(19) United States
(12) Patent Application Publication
(10) Pub. No.: US 2016/0250966 A1
(43) Pub. Date: Sep. 1, 2016

(54) Pressure Sensitive Brake Light System

(71) Applicant: Brad Giguere, North Haven, CT (US)

(72) Inventor: Brad Giguere, North Haven, CT (US)

(21) Appl. No.: 15/051,186

(22) Filed: Feb. 23, 2016

Related U.S. Application Data
(60) Provisional application No. 62/119,738, filed on Feb. 23, 2015.

(51) Int. Cl. B60Q 1/44

(52) U.S. Cl. CPC B60Q 1/444; B60Q 1/441

(57) ABSTRACT

A pressure sensitive brake light system displays increased brightness of the brake lights in direct proportion to the amount of pressure applied to the brake pedal by the user. Each taillight provides a plurality of separately illuminated panels. The system is provided in two embodiments, and is intended for installation as original equipment by the vehicle manufacturer.

### CROSS-REFERENCE TO RELATED APPLICATIONS

This Application claims the benefit of U.S. Provisional Application No. 62/119,738, filed Feb. 23, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to vehicle lighting systems and in particular to a pressure sensitive brake light system. Despite the federally mandated addition of a third brake light, mounted high at the center on all vehicles, rear end collisions still account for a very large percentage of all accidents, including fatal accidents. In nearly all cases these accidents are avoidable. The death toll, and the hundreds of millions of dollars in property damage each year, suggest that a better solution is needed. Pressing the brake pedal harder increases the amount of stopping power applied by the vehicle's brake system, and this should be a variable that is visibly reflected by the vehicle's brake lights, to better enable drivers behind the vehicle to identify the nature of the event which caused the brakes to be applied.

A search of the prior art reveals various brake light systems which have been developed to better enable drivers behind the vehicle to respond appropriately to various braking events. None are closely related to the present invention, but several include features which resemble those of the present invention. Each has proven to be less than satisfactory in its own way. The present invention has been developed for the purpose of addressing and resolving these disadvantages.

Vehicle brake light system, U.S. Pat. No. 6,150,933 (filed Apr. 7, 1999), provides a vehicle brake light system comprised of a plurality of lamps arranged in endless array, a brake pedal linkage operable in response to depression of a brake pedal, and a controller. The controller is operable to effect brief illumination of the lamps in sequence around the array, in response to operation of the brake pedal linkage. The rate at which the lamps are sequentially illuminated increases in accordance with the magnitude of the brake actuation pressure.

Automatic brake light safety system, U.S. Pat. No. 7,710,254 (filed Jun. 5, 2007), provides an integrated progressive brake light system for vehicles in which different sequences of brake lights are illuminated, dependent on operator activation input. The brake light system uses a progressive multiple selective illumination in which additional central oriented brake lights are actuated as increase of operator input is metered, to indicate the relative degree of applied braking force as will be evident to the visual interpretation thereof.

Progressive brake light apparatus, U.S. Pat. No. 7,782,185 (filed Aug. 14, 2007), provides a progressive brake light apparatus which sequentially lights three separate brake lights via hydraulic pressure sensing of the brake system between the master cylinder and the rear brakes. The apparatus provides a brake light assembly with the three distinctly different light sources disposed within, each of different size and different color, the brightest and largest being disposed at the top of the brake light assembly and the smallest and dimmest at the bottom of the brake light assembly. The apparatus thereby provides signal to trailing vehicles of the intensity of braking force applied, and therefore with a distinct signal of only initial brake pressure, versus average stopping, versus intense braking.

Progressive brake light system, U.S. Pat. No. 6,573,830 (priority Feb. 11, 1999), provides a progressive vehicle brake light system comprised of a brake sensor, arranged to sense the travel of a brake pedal, and a brake light display, arranged to illuminate or extinguish in sequence or progressively in response to the travel of the brake pedal. A microcontroller is provided for receiving a signal from the brake sensor and controlling the brake light display accordingly. The brake sensor is typically an optical sensor utilizing infrared transmitters and receivers arranged to sense the distance and direction of travel of the brake pedal. The brake light display consists of a row of light emitting diodes (LEDs) which are arranged to illuminate from the opposite ends towards the middle as the brake pedal is depressed and to extinguish in reverse sequence when the brake pedal is released.

Brake alert device, U.S. Pat. No. 4,663,609 (filed Oct. 21, 1985), provides a brake light warning system for a motor vehicle, which causes the brakes lights to flash in a manner to attract the attention of a driver to the rear of the vehicle and provide a more effective warning of a slow down or stopping of the vehicle, especially during foggy days or nights and when the view of a vehicle is partially obscured. Upon application of the brakes the brake lights are first caused to flash rapidly for 2 or 3 times for a first interval of time, followed by prolonged “on” periods which are interrupted periodically by a short “off” period followed by a short on period followed by a short “off” period for a second interval of time, as long as pressure is applied to the brake pedal of the vehicle.

Vehicle safety signaling system, U.S. Pat. No. 6,870,474 (filed Nov. 25, 2002), provides a signaling system for a motor vehicle to indicate changes in the vehicle's speed during acceleration and deceleration, as well as relative constant speed conditions, to following motorists. A light signaling display is mounted on the rear of the vehicle and is illuminated by multiple light assemblies, some of which have lamps of the three primary colors. A controller determines illumination sequence and intensity, depending on input from sensors on the vehicle's speed controls and a pre-programmed set of illumination patterns.

Most of these inventions rely on different colored brake lights, various lengths of “on” and “off” periods for the brake lights, or various patterns of multiple brake lights to prevent catastrophic rear end collisions, particularly in low visibility conditions such as rain and fog. This creates a disadvantage by making the information conveyed by the brake lights difficult for following drivers to understand and interpret in the split second that is available. The present invention, which provides increasing degrees of brake light brightness to signal the amount of pressure applied to the brake pedal, is very easily interpreted. Thus it resolves the disadvantages of the prior art and is not anticipated by the prior art.

A pressure sensitive brake light system, which increases the brightness of the brake lights in direct proportion to the amount of pressure applied to the brake pedal by the driver, would resolve this problem.

### SUMMARY OF THE INVENTION

Accordingly, the invention is directed to a pressure sensitive brake light system. The system increases the brightness of the brake lights in direct proportion to the amount of pressure applied to the brake pedal by the user. Each taillight provides a plurality of separately illuminated panels. The system is provided in two embodiments, and is intended for installation as original equipment by the vehicle manufacturer.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serve to explain the principles of the invention.

FIG. 1 is a rear breakout view of a vehicle with the first exemplary embodiment installed, displaying the three-panel taillight 10, the 1/3 pressure display 10A, the 2/3 pressure display 10B, the 3/3 pressure display 10C, the panels 12, and the vehicle 13.

FIG. 2 is a rear breakout view of a vehicle with the second exemplary embodiment installed, displaying the five-panel taillight 11, the 1/5 pressure display 11A, the 2/5 pressure display 11B, the 3/5 pressure display 11C, the 4/5 pressure display 11D, the 5/5 pressure display 11E, the panels 12, and the vehicle 13.

FIG. 3 is a side view of the first exemplary embodiment, displaying the pressure switch 20, the brake pedal 21, and the user 22.

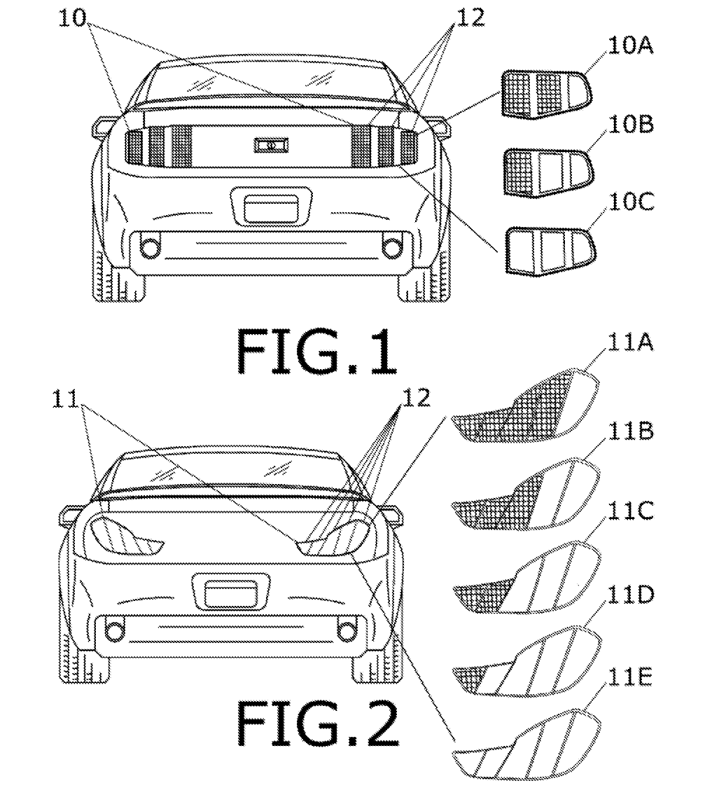

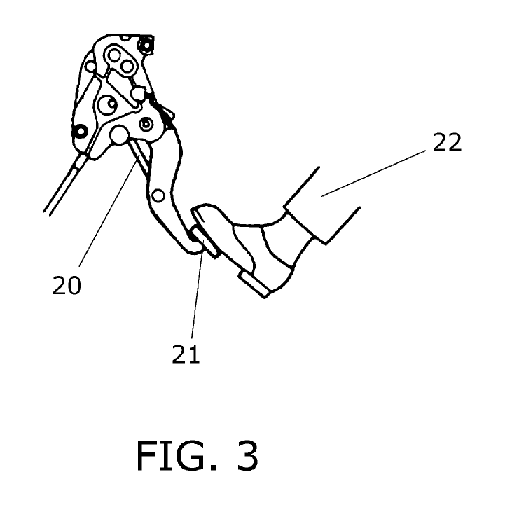

### DETAILED DESCRIPTION OF THE INVENTION

Referring now to the invention in more detail, the invention is directed to a pressure sensitive brake light system.

The invention is intended for installation as original equipment by the manufacturer of the vehicle 13. Alternate embodiments, intended for installation as an after-market modification by the owner of the vehicle 13, or by a repair or customizing shop, are contemplated.

The first exemplary embodiment is comprised of one or more pressure switches 20 connected to the brake pedal 21, and a pair of three-panel taillights 10 which are connected to the pressure switches 20 by wires. Each of the three-panel taillights 10 provides three separately illuminated panels 12. Preferably, the system is powered by the electrical system of the vehicle 13. When the vehicle 13 is being driven at night or in inclement weather, and the user activates the headlights of the vehicle 13, the panels 12 are illuminated at a moderate brightness level, as with a conventional taillight. However, the system increases the brightness of the brake light 10 in direct proportion to the amount of pressure applied to the brake pedal by the user 22, illuminating the panels 12 one by one as pressure on the brake pedal is increased.

When one-third of the maximum brake pressure or less is applied, the outermost panel 12 is brightly illuminated, creating a 1/3 pressure display 10A. When more than one-third, up to two-thirds of the maximum brake pressure is applied, the two outermost panels 12 are brightly illuminated, creating a 2/3 pressure display 10B. When more than two-thirds, up to the maximum brake pressure is applied, all three panels 12 are brightly illuminated, creating a 3/3 pressure display 10C.

The second exemplary embodiment is similar in structure and function to the first exemplary embodiment, with the following modifications. Instead of three-panel taillights 10, the second exemplary embodiment provides a pair of five- panel taillights 11, and each provides five panels 12.

When one-fifth of the maximum brake pressure or less is applied, the outermost panel 12 is brightly illuminated, creating a 1/5 pressure display 11A. When more than one-fifth, up to two-fifths of the maximum brake pressure is applied, the two outermost panels 12 are brightly illuminated, creating a 2/5 pressure display 11B. When more than two-fifths, up to three-fifths of the maximum brake pressure is applied, the three outermost panels 12 are brightly illuminated, creating a 3/5 pressure display 11C. When more than three-fifths, up to four-fifths of the maximum brake pressure is applied, the four outermost panels 12 are brightly illuminated, creating a 4/5 pressure display 11D. When more than four-fifths, up to the maximum brake pressure is applied, all five panels 12 are brightly illuminated, creating a 5/5 pressure display 11E.

Alternate embodiments, providing more or fewer panels 12 in each of the taillights, are also contemplated. The various displays, indicating different levels of pressure on the brake panel, are intended to inform other drivers such that any drivers behind the vehicle 13 are better able to identify the nature of the event which caused the brakes to be applied: whether the user merely wishes to reduce speed by a few miles per hour, slow down enough to turn onto a side street or into a parking lot, or stop the vehicle 13 immediately to avoid an accident. This improved information is intended to enable such drivers to respond appropriately and in a timely manner to avoid a rear-end collision with the vehicle 13.

To use the first exemplary embodiment, the user simply drives the vehicle 13. Operation of the system is automatic.

The three-panel taillights 10 and the five-panel taillights 11 are preferably manufactured from rigid, durable materials such as steel, aluminum alloy, brass, copper alloy, and plastic, providing lenses which are preferably manufactured from a rigid, durable material which is translucent, such as glass, methacrylate, or plastic. The pressure switches are preferably manufactured from rigid, durable materials such as steel, aluminum alloy, copper alloy, and plastic. The wires are preferably manufactured from braided copper alloy wire sheathed in flexible plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A pressure sensitive brake light system, comprising: one or more pressure switches;
said pressure switches being connected to a brake pedal of a vehicle and configured to measure an amount of pressure applied to the brake pedal; a pair of taillights which are electrically connected to the pressure switches; said pair of taillights being configured to illuminate at various taillight illumination levels when the brake pedal is pressed; wherein the taillight illumination level increases in brightness in direct proportion to the amount of pressure applied to the brake pedal.

2. The brake system of claim 1, wherein, when no pressure is on the brake pedal and headlights of the vehicle are deactivated, the pair of taillights are illuminated at an unilluminated brightness level, such that the taillight illumination level increases in brightness in direct proportion to the amount of pressure applied to the brake pedal from unilluminated to a high brightness level.

3. The brake system of claim 1, wherein, when no pressure is on the brake pedal and headlights of the vehicle are activated, the pair of taillights are illuminated at a moderate brightness level, such that the taillight illumination level increases in brightness in direct proportion to the amount of pressure applied to the brake pedal from said moderate brightness level to a high brightness level.

4. The brake system of claim 1, wherein each of the pair of taillights provides three separately illuminated panels.

5. The brake system of claim 4, wherein, when no pressure is on the brake pedal and headlights of the vehicle are deactivated, the pair of taillights are illuminated at an unilluminated brightness level, such that the taillight illumination level increases in brightness in direct proportion to the amount of pressure applied to the brake pedal from unilluminated to a high brightness level.

6. The brake system of claim 4, wherein, when no pressure is on the brake pedal and headlights of the vehicle are activated, the pair of taillights are illuminated at a moderate brightness level, such that the taillight illumination level increases in brightness in direct proportion to the amount of pressure applied to the brake pedal from said moderate brightness level to a high brightness level.

7. The brake system of claim 4, wherein the pair of taillights increase in brightness in direct proportion to the amount of pressure applied to the brake pedal by illuminating the three panels one by one as pressure on the brake pedal is increased and approaches a maximum brake pressure.

8. The brake system of claim 7, wherein when one-third of the maximum brake pressure or less is applied, the outermost panel is brightly illuminated, creating a 1/3 pressure display.

9. The brake system of claim 7, wherein when more than one-third and up to two-thirds of the maximum brake pressure is applied, the two outermost panels are brightly illuminated, creating a 2/3 pressure display.

10. The brake system of claim 7, wherein when more than two-thirds and up to the maximum brake pressure is applied, all three panels are brightly illuminated, creating a 3/3 pressure display.

11. The brake system of claim 1, wherein each pair of taillights provides five separately illuminated panels.

12. The brake system of claim 11, wherein, when no pressure is on the brake pedal and headlights of the vehicle are deactivated, the pair of taillights are illuminated at an unilluminated brightness level, such that the taillight illumination level increases in brightness in direct proportion to the amount of pressure applied to the brake pedal from unilluminated to a high brightness level.

13. The brake system of claim 11, wherein, when no pressure is on the brake pedal and headlights of the vehicle are activated, the pair of taillights are illuminated at a moderate brightness level, such that the taillight illumination level increases in brightness in direct proportion to the amount of pressure applied to the brake pedal from said moderate brightness level to a high brightness level.

14. The brake system of claim 11, wherein the pair of taillights increase in brightness in direct proportion to the amount of pressure applied to the brake pedal by illuminating the five panels one by one as pressure on the brake pedal is increased and approaches a maximum brake pressure.

15. The brake system of claim 14, wherein when one-fifth of the maximum brake pressure or less is applied, the outermost panel is brightly illuminated, creating a 1/5 pressure display.

16. The brake system of claim 14, wherein when more than one-fifth and up to two-fifths of the maximum brake pressure is applied, the two outermost panels are brightly illuminated, creating a 2/5 pressure display.

17. The brake system of claim 14, wherein when more than two-fifths and up to three-fifths of the maximum brake pressure is applied, the three outermost panels are brightly illuminated, creating a 3/5 pressure display.

18. The brake system of claim 14, wherein when more than three-fifths and up to four-fifths of the maximum brake pressure is applied, the four outermost panels are brightly illuminated, creating a 4/5 pressure display.

19. The brake system of claim 14, wherein when more than four-fifths and up to the maximum brake pressure is applied, all five panels are brightly illuminated, creating a 5/5 pressure display.
